(19) United States
(12) Patent Application Publication
(10) Pub. No.: US 2011/0005158 A1
(43) Pub. Date: Jan. 13, 2011

(54) HIP AND RIDGE ROOFING MATERIAL

(76) Inventors: R. Jon Kailey, Monterrey (MX); Jennifer L. Frey, Monclova, OH (US); Lawrence J. Grubka, Westerville, OH (US)

Correspondence Address: MacMillan, Sobanski & Todd, LLC, One Maritime Plaza, Fifth Floor, 720 Water Street, Toledo, OH, 43604, US

(21) Appl. No.: 12/831,130

(22) Filed: Jul. 6, 2010

Related U.S. Application Data
(60) Provisional application No. 61/223,237, filed on Jul. 6, 2009.

(51) Int. Cl. E04D 1/22; B44C 3/02; B05D 1/12

(52) U.S. Cl. 52/518; 428/67; 427/186

(57) ABSTRACT

A shingle blank comprises a substrate coated with an asphalt coating and having an upper surface and a lower surface, the upper surface configured to include a first prime region and a second prime region. The first prime region is substantially covered by prime granules having a first overall visual effect and the second prime region is substantially covered by prime granules having a second overall visual effect different from the first overall visual effect. The shingle blank is capable of being divided into individual cap shingles that can be applied to a roof ridge or hip, with the cap shingles including both the first and second prime regions, thereby enabling the cap shingles to be installed in an overlapping manner on the hip or ridge with either the first or the second prime colors being exposed.

### RELATED APPLICATIONS

This application claims priority from U.S. Provisional Patent Application Ser. No. 61/223,237, filed Jul. 6, 2009, and entitled HIP AND RIDGE ROOFING MATERIAL.

### BACKGROUND OF THE INVENTION

Asphalt-based roofing materials, such as roofing shingles, roll roofing and commercial roofing, are installed on the roofs of buildings to provide protection from the elements. The roofing material may be constructed of a substrate such as a glass fiber mat or an organic felt, an asphalt coating on the substrate, and a surface portion of granules embedded in the asphalt coating.

Roofing materials are applied to roofs having various surfaces formed by roofing planes. The various surfaces and roofing planes form intersections, such as for example, hips and ridges. A ridge is the uppermost horizontal intersection of two sloping roof planes. Hips are formed by the intersection of two sloping roof planes running from a ridge to the eaves. It would be desirable to improve hip and ridge roofing material to provide more efficient installation and manufacturing methods.

### SUMMARY OF THE INVENTION

In accordance with this invention there is provided a shingle blank comprising a substrate coated with an asphalt coating and having an upper surface and a lower surface, the upper surface configured to include a first prime region and a second prime region. The first prime region is substantially covered by prime granules having a first overall visual effect and the second prime region is substantially covered by prime granules having a second overall visual effect different from the first overall visual effect. The shingle blank is capable of being divided into individual cap shingles that can be applied to a roof ridge or hip, with the cap shingles including both the first and second prime regions, thereby enabling the cap shingles to be installed in an overlapping manner on the hip or ridge with either the first or the second prime colors being exposed.

According to this invention there is also provided a method of manufacturing an asphalt-based roofing material, comprising the steps of coating a substrate with an asphalt coating to form an asphalt coated sheet, where the asphalt coated sheet includes an upper surface and a lower surface, the upper surface configured to include a first prime region and a second prime region. A first portion of prime granules is applied to the first prime region, and a second portion of prime granules is applied to the second prime region, where the overall visual effect of the first prime region is different from the overall visual effect of the second prime region. The coated substrate is then cut into shingle blanks.

According to this invention there is also provided a method of installing an asphalt-based hip and ridge roofing material, comprising the steps of providing an asphalt-based shingle blank, the shingle blank having a substrate coated with an asphalt coating and having an upper surface and a lower surface. The upper surface is configured to include a first prime region and a second prime region, where the first prime region is substantially covered by prime granules having a first overall visual effect and the second prime region is substantially covered by prime granules having a second overall visual effect different from the first overall visual effect. Both of the first and second prime regions are configured to be an exposed shingle portion on a hip or a ridge of a roof. The shingle blank is separated into individual cap shingles, with each cap shingle including both the first and second prime regions. It is determined which of the first or second prime regions will be an exposed region of the installed cap shingles, and the cap shingles are installed on the roof.

According to this invention there is also provided a shingle blank having an upper surface and a lower surface, the upper surface being configured to include a first prime region and a second prime region. The first prime region has a first overall visual effect and the second prime region has a second overall visual effect different from the first overall visual effect. The shingle blank is capable of being divided into individual cap shingles that can be applied to a roof ridge or hip, with the cap shingles including both the first and second prime regions, thereby enabling the cap shingles to be installed in an overlapping manner on the hip or ridge with either the first or the second prime colors being exposed.

According to this invention there is also provided a cap shingle having an upper surface and a lower surface. The upper surface is configured to include a first prime region and a second prime region. The first prime region has a first overall visual effect and the second prime region has a second overall visual effect different from the first overall visual effect. The cap shingle is configured to be installed in an overlapping manner on a hip or ridge of a roof with either the first or the second prime colors being exposed.

### BRIEF DESCRIPTION OF THE DRAWINGS

FIG. 1 is a perspective view of a building structure incorporating the hip and ridge roofing material according to the invention.

FIG. 2 is a perspective view of the installation of the ridge roofing material of FIG. 1.

FIG. 3 is a perspective view of a shingle blank used for making the hip and ridge roofing material of FIG. 2.

FIG. 4 is an enlarged cross-sectional view, taken along the line 4-4 of FIG. 3, of a portion of the hip and ridge roofing material of FIG. 3.

FIG. 5A is a perspective view of the shingle blank of FIG. 3 prior to dividing the blank into individual hip and ridge shingles of FIG. 2.

FIG. 5B is a perspective view of the individual cap shingles after the blank of FIG. 5A has been divided.

FIG. 6 is a schematic view in elevation of apparatus for manufacturing asphalt-based hip and ridge roofing material according to the invention.

FIG. 7 is a schematic view in perspective of another embodiment of a shingle blank that can be divided into individual cap shingles.

FIG. 8 is a schematic view in perspective of yet another embodiment of a shingle blank that can be divided into individual cap shingles.

FIG. 9 is a perspective view of a building structure incorporating cap shingles from the shingle blank of FIG. 8

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In accordance with embodiments of the present invention, hip and ridge shingles, and methods to manufacture the hip and ridge shingles, are provided. It will be understood the term “ridge” refers to the intersection of the uppermost sloping roof planes. The term “roof plane” is defined to mean a plane defined by a flat portion of the roof formed by an area of roof deck. The term “hip” is defined to mean the intersection of sloping roof planes located below the ridge. It will be understood the term “slope” is defined to mean the degree of incline of a roof plane. The term “granule” is defined to mean particles that are applied to a shingle that is installed on a roof. The term “prime granules”, as used herein, is defined to mean granules used for the purposes of protection from harmful UV light and presenting a desired aesthetically pleasing roof appearance.

The description and figures disclose hip and ridge roofing material for a roofing system. In a nonlimiting example, the hip and ridge roofing material is comprised of cap shingles that include two regions having prime granules providing differing overall visual effects positioned on either side of a transition region. A sealant line is positioned on the surface of the transition region. The sealant is optional, and it is also understood that the sealant can be placed on the bottom of the cap shingle as well. Also, the sealant can be applied in a different manner, or using an off-line process, or by the installer. As will be explained in detail below, the two regions of prime granules provide flexibility to the shingle installer, and allow the shingle distributor to maintain a smaller inventory of cap shingles. With reference to FIG. 1, a building structure 10 is shown having a shingle-based roofing system 12. While the building structure 10 illustrated in FIG. 1 is a residential home, it should be understood that the building structure 10 can be any type of residential, commercial or industrial structure having a shingle-based roofing system 12.

The building structure 10 has a plurality of roof planes 14a-14d. Each of the roof planes 14a-14d has a slope. While the roof planes 14a-14d shown in FIG. 1 have their respective illustrated slopes, it should be understood that the roof planes 14a-14d can have any suitable slope. The intersection of the roof planes 14b and 14c form a hip 16. Similarly, the intersection of the roof planes 14b and 14d form a ridge 18.

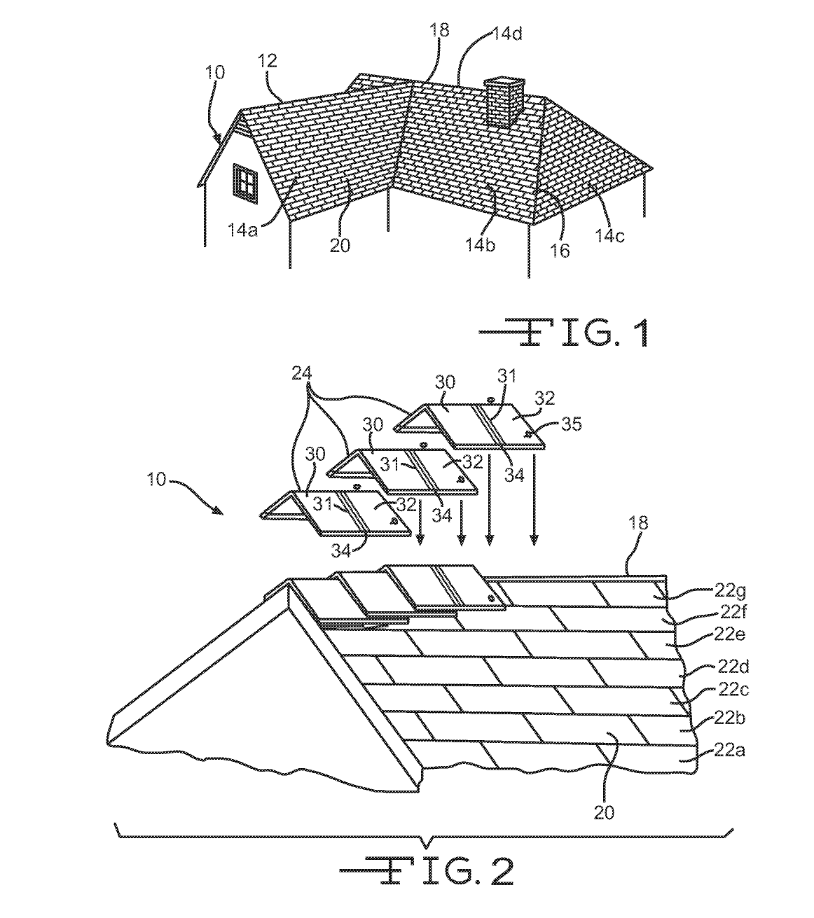

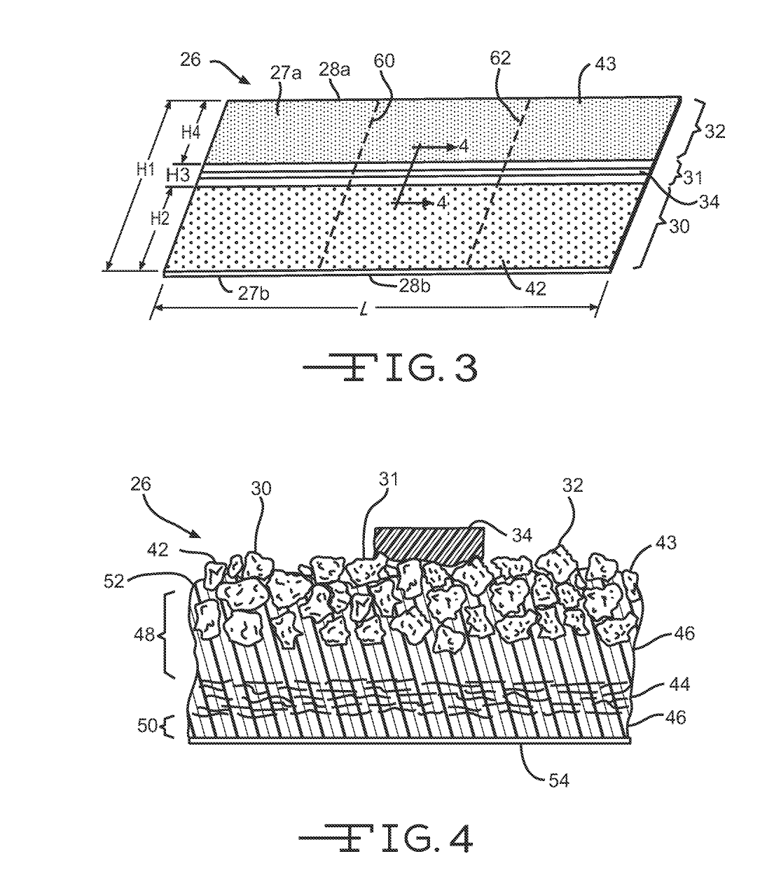

The building structure 10 is covered by the roofing system 12 having a plurality of shingles 20. As shown in FIG. 2, the shingles 20 are installed on the various roof decks in generally horizontal courses 22a-22g in which the shingles of each successive course overlap the shingles of its preceding course. The shingles 20 can be any desired shingle, having any desired structure, design, appearance and orientation. Non-limiting examples include strip shingles and laminated shingles.

Hip and ridge roofing materials, referred to hereinafter as cap shingles, are installed to protect hips, ridges and rakes from the elements and also to provide cover for the shingles on the roof decks forming the hips and ridges. Referring now to FIG. 2, cap shingles 24 are installed on the ridge 18 and over the shingles 20. In a similar fashion, cap shingles 24 are installed on a hip and over the shingles. The method of installing the cap shingles 24 will be discussed in more detail below.

Referring now to FIG. 3, cap shingles 24 are made from a shingle blank 26. The shingle blank 26 has an upper surface 27a, a lower surface 27b, an upper edge 28a and a lower edge 28b. The upper surface 27a includes a first prime region 30, a transition region 31, a second prime region 32 and a sealant line 34. As will be explained in more detail below, the installer of the cap shingles 24 determines whether the first prime region 30 or the second prime region 32 will be exposed when the cap shingles 24 are installed. If the first prime region 30 remains exposed after installation, then the transition region 31 and the second prime region 32 will be covered by successive overlapping cap shingles 24 when the cap shingles 24 are installed. Similarly, if the second prime region 32 remains exposed after installation, then the transition region 31 and the first prime region 30 will be covered by successive overlapping cap shingles 24 when the cap shingles 24 are installed. It can be seen that by providing a cap shingle 24 having a first color appearance on the first prime region 30 and a second, different, color appearance on the second prime region 32, the cap shingle can be used to match a roof covered with a field or appearance of either of the first or second color.

Referring again to FIG. 3, the shingle blank 26 may have any suitable dimensions. The shingle blank 26 may also be divided between the first prime region 30, the transition region 31 and the second prime region 32 in any suitable proportion. For example, a typical residential roofing shingle blank 26 has a length L of approximately 36.0 inches (91.5 cm) and a height H1 of approximately 12.0 inches (30.5 cm), with the height H1 dimension being divided between the first prime region 30, the transition region 31 and the second prime region 32. In one embodiment, the heights H2 and H4 of the first and second prime regions, 30 and 32 are approximately 5.25 inches (13.34 cm) and the height H3 of the transition region 31 is approximately 1.50 inches (3.81 cm). Alternatively, the length L and the heights H1, H2, H3 and H4 can be different.

As further shown in FIG. 3, the shingle blank 26 includes first and second perforation lines, 60 and 62. As will be discussed in more detail below, the first and second perforation lines, 60 and 62, are configured to allow separation of the shingle blank 26 into three pieces, thereby forming cap shingles 24. While the embodiment shown in FIG. 3 illustrates two perforation lines, 60 and 62, providing three cap shingles 24, it should be understood that more or less than two perforation lines, providing more or less than three cap shingles 24 can be used.

Referring again to FIG. 3, the upper surface 27a of the shingle blank 26 includes a sealant line 34. The sealant line 34 is configured to provide an adhesive seal for subsequent overlapping cap shingles 24 when installed on the roof. In the illustrated embodiment, the sealant line 34 is positioned upon the transition region 31 and oriented in a direction substantially parallel to the upper edge 28a of the shingle blank 26. However, the sealant line 34 can be positioned in other desired locations and oriented in other desired directions. The sealant line 34 can be any suitable adhesive and can be applied in any form or configuration. In the illustrated embodiment, the sealant line 34 is a continuous strip, having a substantially uniform width in a range of from about 0.25 inches (0.63 cm) to about 0.38 inches (0.95 cm). Alternatively, the sealant line 34 can be a discontinuous strip or strips having varying widths less than about 0.25 inches (0.63 cm) or more than about 0.38 inches (0.95 cm). In the illustrated embodiment, the sealant line 34 is configured to substantially span the length L of the shingle blank 26. However, the sealant line 34 can be configured for other lengths.

As shown in FIG. 3, the first prime region 30 includes a first portion having a prime covering of prime granules 42 and the second prime region 32 includes a second prime covering including a second portion of prime granules 43. The first and second portions of prime granules, 42 and 43, can be any desired prime granule and can have any desired size and color. Non-limiting examples of prime granules can include lightweight granules, antimicrobial granules, coated granules, energy efficient granules and mixtures thereof. In another example, in place of granules, one or both of the prime coverings for the prime regions 30, 32 may include other materials, such as, for example, polymeric materials or metallic materials to provide an overall visual effect.

Referring again to FIG. 3, the first portion of granules 42 provides the first prime region 30 with a first overall visual effect. Similarly, the second portion of granules 43 provides the second prime region 32 with a second overall visual effect. The first overall visual effect of the first portion of granules 42 in the first prime region 30 is different from the second overall visual effect of the second portion of granules 43 in the second prime region 32. As one non-limiting example, the first overall visual effect of the first prime region 30 is a first color, such as brown, and configured to be generally compatible with a roof having an overall brown coloration or field color. The second overall visual effect of the second prime region 32 could be a second color, such as grey, and configured to be generally compatible with a roof having an overall grey coloration. Another non-limiting example of an overall visual effect comprises providing an outline or other decorative pattern.

As will be explained in more detail below, the difference in the overall visual effects of the first and second prime regions, 30 and 32, provides flexibility to the installer of the hip and ridge roofing materials. Also, providing two different colors enables the distributor to supply the cap shingle needs of its customers with a smaller inventory.

The difference in the appearance between the first and second prime regions 30 and 32 is not limited to the color. The difference in appearance includes other possible differences besides differences between the color of the first prime region and the second prime region. For example, the differences can also be manifested by having a shadow line on one prime region, and not on the other prime region. Additionally, one prime region could be thicker than the other prime region, or have the appearance of being thicker. When any of these differences is employed, the installer is advantageously given flexibility, and the opportunity for reduced inventories is also provided. Similarly, the installer may choose to use the colors to provide different designs for the roof, for example by alternating the colored shingles on a given roof, or applying shadow lines only in certain areas. In one example, the colors of the shingles are alternated to compliment the shingles described in commonly assigned copending U.S. application Ser. No. 09/515,928, which is incorporated herein by reference in its entirety, to accomplish a slate appearance. In such an embodiment, the shape of the prime region may be modified to compliment the design of the tabs shown in the '928 application.

The transition region 31 may include a mixture of the first portion of granules 42 and the second portion of granules 43. The transition region 31 is configured to be covered by successive overlapping cap shingles 24 when the cap shingles 24 are installed. Alternatively, the transition region can be made with headlap granules.

Referring now to FIG. 4, one embodiment of the composition of the shingle blank 26 is illustrated. The shingle blank 26 includes a substrate 44 that is coated with an asphalt coating 46. The substrate 44 can be any suitable substrate for use in reinforcing asphalt-based roofing materials, including, but not limited to fibrous materials such as glass fibers or organic fibers.

The asphalt coating 46 includes an upper section 48 that is positioned above the substrate 44 when the roofing material is installed on a roof, and a lower section 50 that is positioned below the substrate 44. The upper section 48 includes an upper surface 52. The term “asphalt coating” means any type of bituminous material suitable for use on a roofing material, including, but not limited to asphalts, tars, pitches, or mixtures thereof. The asphalt can be either manufactured asphalt produced by refining petroleum or naturally occurring asphalt. The asphalt coating 46 can include various additives and/or modifiers, such as inorganic fillers or mineral stabilizers, organic materials such as polymers, recycled streams, or ground tire rubber.

Referring again to FIG. 4, the first portion of granules 42 is pressed into the upper surface 52 of the upper section 48 of the first prime region 30 and the transition region 31. Similarly, the second portion of granules 43 is pressed into the upper surface 52 of the upper section 48 of the second prime region 30 and the transition region 31. The sealant line 34 is applied upon the transition region 31. Optionally, the lower section 50 can be coated with a suitable backdust material 54.

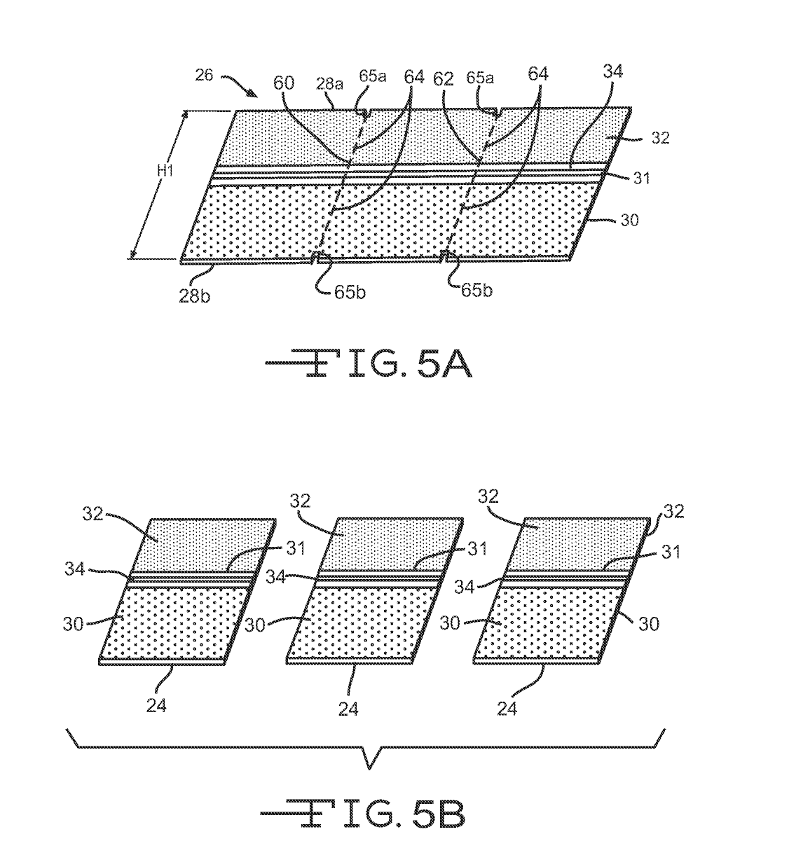

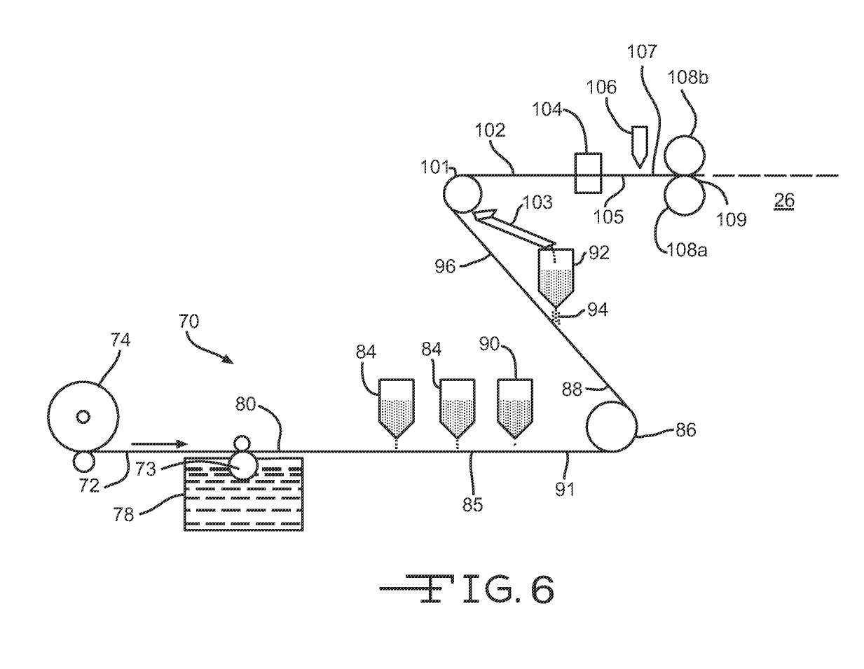

Referring now to FIGS. 5A and 5B, the first perforation line 60 and the second perforation line 62 include perforations 64. The first and second perforation lines, 60 and 62, are spaced apart and are substantially perpendicular to the lower edge 28b of the shingle blank 26 and span the height H1 of the shingle blank 26. The first and second perforation lines, 60 and 62, are positioned such that subsequent separation of the shingle blank 26 along the first and second perforation lines, 60 and 62, forms cap shingles 24. In the illustrated embodiment, each of the formed cap shingles 24 has a length of approximately 12.0 inches (30.5 cm). In other embodiments, the first and second perforation lines, 60 and 62, can be positioned at different spacing relative to each other, to result in formed cap shingles having any desired lengths.

In the illustrated embodiment, the perforations 64 extend through the upper section 48 of the asphalt coating 46, the substrate 44 and the lower section 50 of the asphalt coating 46. In other embodiments, the perforations 64 extend through less than all of the layers of the shingle blank 26. The length of the perforations 64 can be any desired dimension. Similarly, the pattern of the perforations 64 can be arranged in any desired manner suitable to form the first and second perforation lines, 60 and 62.

The perforations 64 are configured such that an installer is able to separate the shingle blanks 26 into the cap shingles 24 at the installation site. In the illustrated embodiment, the first and second perforation lines, 60 and 62, extend the full height H1 of the shingle blank 26. Alternatively, the first and second perforation lines, 60 and 62, can extend any length sufficient to enable an installer to separate the shingle blanks 26 into the cap shingles 24 at an installation site. In other embodiments, the shingle blanks 26 include a plurality of lines (not shown) in lieu of the first and second perforation lines, 60 and 62. The lines are configured to provide a cutting guide for the installer to cut the shingle blank 26 into ridge roofing material. Any quantity of lines can be provided.

Referring again to FIGS. 5A and 5B, the shingle blank 26 can include a plurality of optional courtesy cuts 65b positioned in the first prime region 30 and a plurality of courtesy cuts 65a positioned in the second prime region 32. The courtesy cuts 65a and 65b are configured to assist the installer in separating the shingle blanks 26 into individual cap shingles 24. In the illustrated embodiment, the courtesy cuts 65a are configured to substantially align with corresponding courtesy cuts 65b on the opposite side of the shingle. In the illustrated embodiment, the courtesy cuts 65a and 65b extend substantially through the thickness of the shingle blank 26. In other embodiments, the courtesy cuts 65a and 65b can extend through any suitable layers of the shingle blank 26. The courtesy cuts 65a can extend from the upper edge 28a of the shingle blank 26 across the second prime region 32 any desired distance. Similarly, the courtesy cuts 65b can extend from the lower edge 28b of the shingle blank 26 across the first prime region 30 any desired distance.

While the embodiment shown in FIG. 5 illustrates a quantity of two courtesy cuts 65a positioned in the second prime region 32 and a quantity of two courtesy cuts 65b positioned in the first prime region 30, it should be appreciated that any desired quantity of courtesy cuts can be positioned in the first and second prime regions, 30 and 32. As will be explained below in more detail, the courtesy cuts 65a and 65b are provided in the shingle blank 26 during the manufacture of the shingle blank 26.

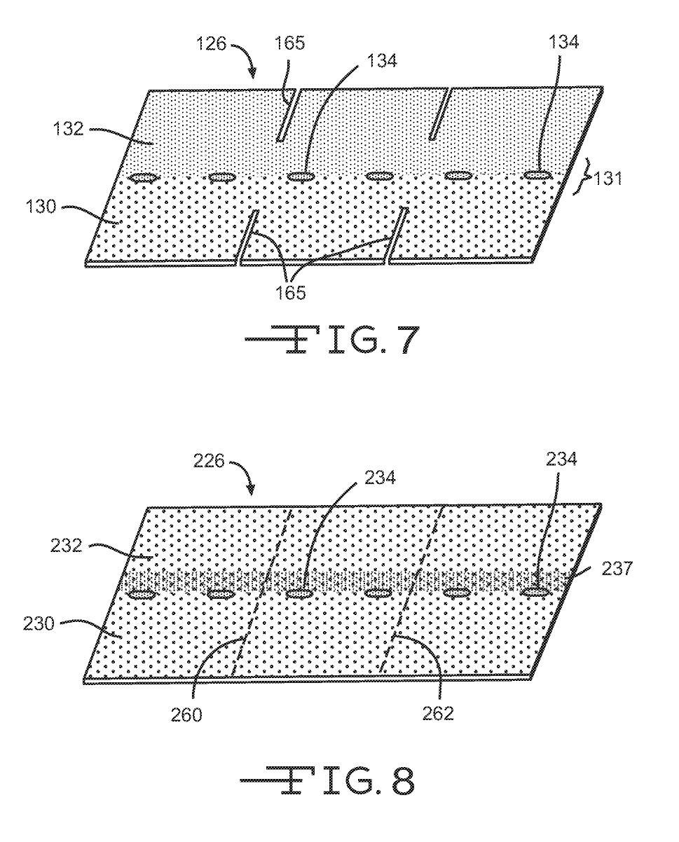

Referring now to FIG. 6, an apparatus 70 for manufacturing shingle blanks 26 is illustrated. The manufacturing process involves passing a continuous sheet 72 in a machine direction (indicated by the arrow) through a series of manufacturing operations. The sheet 72 usually moves at a speed of at least about 200 feet/minute (61 meters/minute), and typically at a speed within the range of between about 450 feet/minute (137 meters/minute) and about 800 feet/minute (244 meters/minute). The sheet 72, however, may move at any desired speed.

In a first step of the illustrated manufacturing process, a continuous sheet of substrate or shingle mat 72 is payed out from a roll 74. The substrate can be any type suitable for use in reinforcing asphalt-based roofing materials, such as a non-woven web of glass fibers. The shingle mat 72 may be fed through a coater 78 where an asphalt coating can be applied to the shingle mat 72. The asphalt coating can be applied in any suitable manner. In the illustrated embodiment, the shingle mat 72 contacts a roller 73 that is in contact with a supply of hot, melted asphalt. The roller 73 substantially covers the shingle mat 72 with a tacky coating of hot, melted asphalt to define a first asphalt coated sheet 80. In other embodiments, however, the asphalt coating could be sprayed on, rolled on, or applied to the shingle mat 72 by other means. In some embodiments, the asphalt material is highly filled with a ground stone filler material, amounting to at least about 60 percent by weight of the asphalt/filler combination.

The resulting asphalt coated sheet 80 is then passed beneath a series of granule dispensers 84 for the application of granules to the upper surface 27a of the asphalt coated sheet 80. While the illustrated embodiment shows two granule dispensers 84, it should be understood that any number of granule dispensers 84 can be used. The granule dispensers 84 can be of any type suitable for depositing granules onto the asphalt coated sheet 80. A granule dispenser that can be used is a granule valve of the type disclosed in U.S. Pat. No. 6,610,147 to Aschenbeck, which is incorporated herein by reference in its entirety. The granule dispensers 84 are configured to provide a blend of prime granules of the desired color blend to the first prime region 30 and prime granules of the desired different color blend to the second prime region 32. The granules from the first portion of prime granules 42 and the granules from the second portion of prime granules 43 may somewhat overlap in the transition region 31. The granule dispensers 84 are supplied with granules from sources of granules, not shown. After all the granules are deposited on the asphalt coated sheet 80 by the series of granule dispensers 84, the asphalt coated sheet 80 becomes a prime granule covered sheet 85.

The prime granule covered sheet 85 is then passed beneath a backfall hopper 90. The backfall hopper 90 is configured for application of background granules to the upper surface 27a of the prime granule covered sheet 85. While the illustrated embodiment shows a single backfall hopper 90, it should be understood that any number of backfall hoppers 90 can be used. The backfall hopper 90 can be of any type suitable for depositing background granules onto the prime granule covered sheet 85. After all the background granules are deposited on the prime granule covered sheet 85 by the backfall hopper 90, the prime granule covered sheet 85 becomes a granule covered sheet 91.

The granule covered sheet 91 is then turned around a slate drum 86 to press the granules into the asphalt coating and to temporarily invert the granule covered sheet 91 so that the excess granules will fall off and will be recovered and reused. While the embodiment shown in FIG. 6 illustrates a slate drum configured to press the granules into the asphalt coating, it should be appreciated that other mechanisms and devices, such as for example press rollers, can be used. Turning the granule covered sheet 91 around the slate drum 86 forms inverted sheet 88.

In one embodiment, as shown in FIG. 6, a backdust applicator 92 is positioned to apply a thin layer of backdust material 94 to a bottom surface of the inverted sheet 88. The backdust material 94 is configured to adhere to the bottom surface of the inverted sheet 88 and results in a substantially less tacky bottom surface for downstream shingle production operations. The backdust material 94 can be any material, such as for example natural rock dust, sand or small glass particles, sufficient to adhere to the bottom surface of the inverted sheet 88 and result in a substantially less tacky bottom surface. Application of the backdust material 94 to the inverted sheet 88 forms dusted inverted sheet 96.

In another nonlimiting example, the bottom side of the sheet has colored granules applied in a similar manner as the top side, such that two additional colors, styles or shades can be accomplished for a total of four variations on a single sheet. In this embodiment, an adhesive bead may be applied to one or both transition regions (top and bottom), or the adhesive may be field applied during installation. In yet another nonlimiting example, the top surface of the sheet has a first overall visual effect and the bottom of the sheet has a second overall visual effect.

Subsequent to the application of the backdust material 94 to the inverted sheet 88, the dusted inverted sheet 96 is turned around a sand drum 101 to press the backdust material 94 into the bottom surface of the dusted inverted sheet 96. Excess backdust material is collected in the backdust collector 103 and is recycled back into the backdust applicator 92. The backdust collector 103 can be any desired structure, mechanism or device. Pressing the backdust material 96 into the dusted inverted sheet 96 forms pressed sheet 102.

Referring again to FIG. 6, the pressed sheet 102 is cooled by any suitable cooling apparatus 104, or allowed to cool at ambient temperature to form a cooled sheet 105.

The cooled sheet 105 is passed through a sealant applicator 106. The sealant applicator 106 is configured to apply the sealant line 34 to the upper surface 27a of the cooled sheet 105. The sealant applicator 106 can be any suitable mechanism for applying the sealant line 34 to the cooled sheet 105. In the illustrated embodiment, a single sealant applicator 106 is shown. Alternatively, any number of sealant applicators 106 can be used to create one or more beads of sealant in either a continuous or discontinuous manner. Application of the sealant line 34 to the cooled sheet 105 forms sealant lined sheet 107.

The sealant lined sheet 107 is passed through cutting roller 108a and anvil roller 108b. In the illustrated embodiment, the rollers, 108a and 108b, are configured to perform several manufacturing operations. First, the cutting roller 108a and the anvil roller 108b are configured to form the perforation lines 60 and 62, each having the perforations 64. As discussed above, the perforations 64 can have any desired configuration and the perforation lines 60 and 62 can be positioned in any desired location. The cutting roller 108a includes a plurality of perforating knives 109 configured to form the perforations 64 as the cutting roller 108a rotates and contacts the sealant lined sheet 107. Last, the cutting roller 108a and the anvil roller 108b are configured to cut the sealant lined sheet 107 to form individual shingle blanks 26.

In other embodiments, rather than configuring the cutting roller 108a to cut the sealant lined sheet 107 into individual shingle blanks 26, the cutting roller 108a can be configured to cut the sealant lined sheet 107 into cap shingles 24. In these embodiments, the cap shingles 24 are delivered to the installation site in a ready to install condition, without requiring separation.

While FIG. 6 illustrates one example of an apparatus 70 configured for manufacturing the shingle blanks 26, it should be understood that other suitable structures, mechanisms and apparatus or combinations of structures, mechanisms and apparatus can be used. While the embodiment shown in FIG. 6 illustrates the perforating and cutting processes as a single process, it is within the contemplation of this invention that the perforating and cutting processes can be completed at different times and by different apparatus. In yet another embodiment, it is contemplated that the cuts penetrate the sheet completely, and are not perforations, thereby forming pre-cut discrete cap shingles 24 as illustrated in FIG. 5B.

While the apparatus is shown and described in terms of a continuous process, it should be understood that the manufacturing method can also be practiced in a batch process using discreet lengths of materials instead of continuous sheets.

Referring again to FIG. 5, the shingle blanks 26 arrive at the installation site having perforation lines 60 and 62. During installation, the roofing installer cuts or tears the shingle blank 26 along the perforation lines 60 and 62 to form cap shingles 24. The cap shingles 24 have the first prime region 30, the transition region 31, the second prime region 32 and sealant line 34.

Referring again to FIG. 2, the cap shingles 24 are installed in an overlapping sequence according to the following process. First, the installer determines whether the first prime region 30 or the second prime region 32 will be exposed on the installed hip or ridge. The determination of which prime region is exposed can include many factors, including the non-limiting examples of the color of the existing shingles 20 and the desired appearance of the hip or ridge. In the illustrated embodiment, the first prime region 30 will be exposed on the installed ridge 18. The installer positions an initial cap shingle 24 such that the lower surface 27b of the cap shingles 24 will contact the ridge 18 and the first prime region 30 will be exposed. In this position, the sealant line 34 is substantially perpendicular to the ridge 18. The initial cap shingle 24 is folded or bent to conform to the ridge contour, so that it lies flat with each of the shingled surfaces 14a on either side of the ridge line. The first cap shingle 24 is then attached to the course 22g of shingles 20 in any desired manner, such as for example by applying roofing nails positioned in the unexposed second prime region 32.

Next, subsequent cap shingles 24 are attached to the installed roofing materials in an overlapping manner such that the subsequent cap shingles 24 overlap the sealant line 34 of the installed cap shingles 24. The sealant line 34 is configured to be positioned between the overlapping ridge roofing materials so that it will bond the subsequent cap shingle to the previous cap shingle.

In other embodiments, the installer may determine that the second prime region 32 should be the exposed region. In this event, the installer merely rotates the cap shingles 24 such that the second prime region 32 is in an exposed position. The flexibility provided to the installer in having the choice between two or more overall visual effects as the exposed prime region advantageously allows inventories of shingle blanks to be substantially reduced.

As shown in FIG. 7, in another embodiment, the shingle blank 126 includes a first prime region 130 and a second prime region 132, with the color of the first prime region 130 being different from the color of the second prime region 132. In a central transition zone 131 the granules of the two different colors may somewhat overlap. A sealant line 134 extends along the transition zone of the shingle blank. The shingle blank 126 includes extended courtesy cuts or cutouts 165 to assist the installer in cutting the shingle blank 125 into individual cap shingles. It is to be understood that in other embodiments, the shingle blank has perforation lines instead of the courtesy cuts 165 to assist the installer in dividing the shingle blank into individual cap shingles.

It may be advantageous during installation to trim the edges of the hidden prime region portion of the cap shingle prior to installation. The purpose of having the installer trim the edges of the hidden prime portion is to assure that the underlying layer of the hidden prime portion does not show at the horizontal edges of the cap shingles. In one embodiment, the perforation lines 60 and 62 are arranged askew, or not perpendicular to the upper and lower edges 28a, 28b of the shingle blank 26. This will automatically provide some of the prime areas with a narrowed profile for hiding underneath the overlying cap shingle. The extended courtesy cuts or cutouts 165 shown in FIG. 7 may be sufficient to enable the cap shingles to be installed without any trimming and yet have the underlying prime portion hidden from view.

While the invention described and illustrated above concerns hip and ridge roofing materials, it is within the contemplation of this invention that other shingles can include the structure of two regions having prime granules of differing overall visual effects.

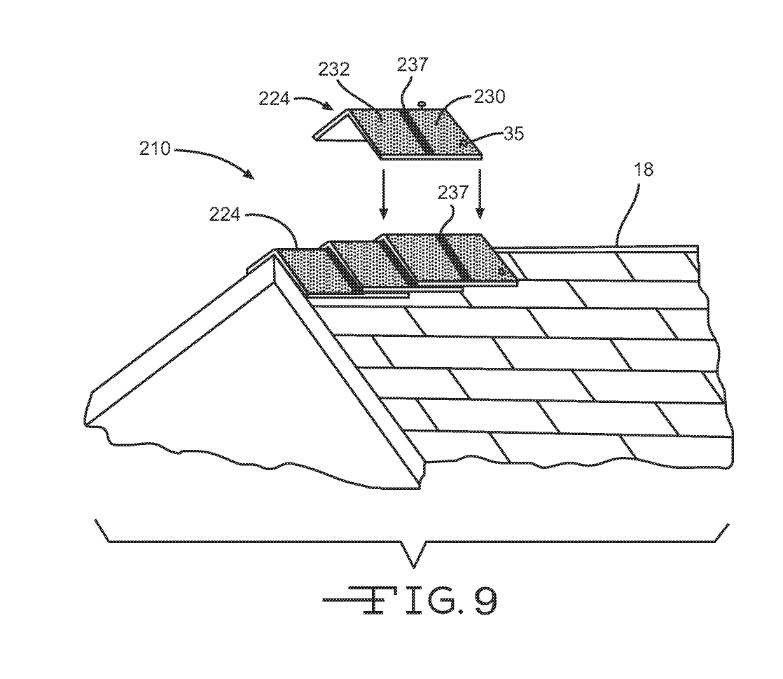

FIGS. 8 and 9 illustrate a roofing structure 210 in which the difference between the first overall visual effect and the second overall visual effect is that the second overall visual effect includes a shadow line 237. The shingle blank 226 includes two prime regions 230 and 232 having the same overall granule color. Prime region 232 includes a shadow line 237 extending longitudinally along the blank. When the shingle blank 226 is cut into cap shingles 224, the shadow line 237 is retained in the prime region 232. When the cap shingle 224 is installed on the roof ridge or hip, the installer can select either the prime region 232 with the shadow line 237, or the prime region 230 without the shadow line, to be the exposed portion. Although in this embodiment the granules of each of the two prime regions 230, 232 are the same, it is to be understood that the granules can be of different color as well as being different in appearance because of the presence of the shadow line.

When selecting the two different colors to be combined into a shingle blank, it may be advantageous to select a popular or frequently used color as the color for the first prime region, and a seldom used color as the color of the second prime region. In other embodiments different selection criteria can be used. When the two colors of the two prime regions 30, 32 are a dark color and a light color, respectively, such as black and white, it may be more important that the underlying prime regions of the cap shingles are completely hidden by the overlying exposed prime region. Otherwise an undesirable thin horizontal line of exposed white granules may be visible at the edge of the cap shingles where the exposed portions of the shingles are dark. In the reverse scenario, where the exposed color is white and a hidden color is black, a thin exposed line of black granules from the underlying black prime layer will less likely be noticeable. Accordingly, it may be necessary to trim the white portion if it is to be hidden, and not necessary to trim the black portion if it is to be hidden. In one embodiment, a thin, dark shadow line could be added to the edges of the light colored portion, such as, of example, to the edges of a white portion, so that when the white portion is covered on the roof with the prime portion of the next cap shingle, only the dark color will be visible. In some cases, the cutouts 165, shown in FIG. 7, will be sufficient to cause the white covered up portion to be completely hidden by the next applied cap shingle.

In one embodiment, the selection of prime shingle color combinations for the dual color shingle blanks includes providing shingles of generally medium or dark colors only, and choosing not to select light colors for the dual color shingle blanks. In one such an embodiment, colors selected for the dual prime color shingle blank for the cap shingles are limited to colors less than or equal to 50 as measured on the CIELAB L* scale.

In another embodiment, the light colors are paired only with other light colors, such as, for example, pairing white with light gray, and darker colors are paired only with other darker colors. In a specific embodiment, the difference in color, ΔE, between the two colors of the dual color shingle blank is less than 25 using CIELAB measurements.

It is to be understood that in other embodiments the colors for the dual prime shingle blank can be selected by other criteria.

Although the examples shown above pertain to asphalt shingles, it is to be understood that the dual-color cap shingles can be made of other materials, such as, for example, polymeric materials or metallic materials. Such shingles would still have the upper surface configured to include a first prime region and a second prime region, where the first prime region has a first overall visual effect and the second prime region has a second overall visual effect different from the first overall visual effect, with the cap shingles being configured to be installed in an overlapping manner on a hip or ridge of a roof with either the first or the second prime colors being exposed. Similarly, although a single-ply hip and ridge shingle is described and illustrated, a multi-layer shingle may be made according to the principles of the present invention. One example of such a shingle would be made in a manner similar to that described in commonly assigned U.S. Pat. No. 6,494,010, which is incorporated herein by reference in its entirety. In one embodiment, a multi-layer shingle is made similar to the cross section illustrated in FIG. 2 of the '010 patent, but the riser 16 would be preferably adhered to the bottom surface (or the riser would be eliminated). The top sheet would preferably resemble FIG. 3 of this application. In another example, more than one riser may be applied to a single layer sheet, as described in the '010 patent. Furthermore, risers in the preceding examples could be applied to each end of the shingle blank to provide for alternative multi-layer blanks, or could be selectively applied to provide the option of either a thick or thin blank as the overall visual effect.

The principle and mode of operation of this invention have been described in its preferred embodiments. However, it should be noted that this invention may be practiced otherwise than as specifically illustrated and described without departing from its scope.

What is claimed is:

1. A shingle blank comprising a substrate coated with an asphalt coating and having an upper surface and a lower surface, the blank including a first prime region and a second prime region, wherein the first prime region is substantially covered by a prime covering having a first overall visual effect and the second prime region is substantially covered by a second prime covering having a second overall visual effect different from the first overall visual effect, with the shingle blank being capable of being divided into individual cap shingles that can be applied to a roof ridge or hip, with the cap shingles including both the first and second prime regions, thereby enabling the cap shingles to be installed in an overlapping manner on the hip or ridge with either the first or the second prime regions being exposed.

2. The shingle blank of claim 1 including perforation lines to aid the cutting of the shingle blank into individual cap shingles.

3. The shingle blank of claim 1 in which the overall visual effect comprises prime coverings made from prime granules having a difference in color, ΔE, between the first overall visual effect and the second overall visual effect, the difference being less than 25 using CIELAB measurements.

4. The shingle blank of claim 1 in which the first overall visual effect comprises first prime granules of a first dark color and the second overall visual effect comprises second prime granules of a second dark color.

5. The shingle blank of claim 1 in which the first overall visual effect comprises first prime granules having a frequently used color and the second overall visual effect comprises second prime granules having a seldomly used color.

6. The shingle blank of claim 1 including courtesy cuts to aid the cutting of the shingle blank into individual cap shingles.

7. The shingle blank of claim 1 in which the colors selected for the first overall visual effect and the second overall visual effect are prime coverings made from prime granules having limited to colors less than or equal to 50 as measured on the CIELAB L* scale.

8. The shingle blank of claim 1 wherein the difference between the first overall visual effect and the second overall visual effect is that the second overall visual effect includes a shadow line.

9. The shingle blank of claim 1 wherein the first and second prime regions are provided on the upper surface of the shingle blank, said blank further comprising a sealant line is positioned on the upper surface of the shingle blank between the first and second prime regions.

10. A method of manufacturing an asphalt-based roofing material, comprising the steps of:
coating a substrate with an asphalt coating to form an asphalt coated sheet, the asphalt coated sheet including an upper surface and a lower surface, the substrate configured to include a first prime region and a second prime region;
applying a first portion of prime granules to the first prime region;
applying a second portion of prime granules to the second prime region, wherein the overall visual effect of the first prime region is different from the overall visual effect of the second prime region; and
cutting the coated substrate into shingle blanks.

11. The method of claim 10 including adding perforation lines to the coated substrate to facilitate the separation of the shingle blank into cap shingles.

12. The method of claim 10 in which the overall visual effect comprises a difference in color, ΔE, between the first overall visual effect and the second overall visual effect, said difference being less than 25 using CIELAB measurements.

13. The method of claim 10 in which the first overall visual effect comprises a dark color and the second overall visual effect comprises a dark color.

14. The method of claim 10 in which the first overall visual effect comprises a frequently used color and the second overall visual effect comprises a seldomly used color

15. The method of claim 10 in which colors selected for the first overall visual effect and the second overall visual effect are limited to colors less than or equal to 50 as measured on the CIELAB L* scale.

16. The method of claim 10 including applying a shadow line to at least one of the prime regions.

17. A method of installing an asphalt-based hip and ridge roofing material, comprising the steps of:
providing an asphalt-based shingle blank, the shingle blank having a substrate coated with an asphalt coating and having an upper surface and a lower surface, the substrate configured to include a first prime region and a second prime region, wherein the first prime region is substantially covered by prime granules having a first overall visual effect and the second prime region is substantially covered by prime granules having a second overall visual effect different from the first overall visual effect, wherein both of the first and second prime regions are configured to be an exposed shingle portion on a hip or a ridge of a roof;
separating the shingle blank into individual cap shingles, each cap shingle including both the first and second prime regions;
determining which of the first or second prime regions will be an exposed region of the installed cap shingles; and
installing the cap shingles on the roof.

18. The method of claim 17 including trimming the edges of the prime region of the cap shingle that is to be hidden and not exposed.

19. The method of claim 17 in which the first overall visual effect is a first dark color and the second overall visual effect is a second dark color.

20. The method of claim 17 in which the first overall visual effect is a frequently used color and the second overall visual effect is a seldomly used color

21. A shingle blank having an upper surface and a lower surface, the blank configured to include a first prime region and a second prime region, wherein the first prime region has a first overall visual effect and the second prime region has a second overall visual effect different from the first overall visual effect, with the shingle blank being capable of being divided into individual cap shingles for application to a roof ridge or hip, with the cap shingles including both the first and second prime regions, thereby enabling the cap shingles to be installed in an overlapping manner on the hip or ridge with either the first or the second prime colors being exposed.

22. The shingle blank of claim 21 in which the shingle blank is a metallic material.

23. The shingle blank of claim 21 in which the shingle blank is comprised of a substrate coated with an asphalt coating, with the first prime region being substantially covered by prime granules having the first overall visual effect and the second prime region being substantially covered by prime granules having the second overall visual effect.

24. A cap shingle having an upper surface and a lower surface, the upper surface configured to include a first prime region and a second prime region, wherein the first prime region has a first overall visual effect and the second prime region has a second overall visual effect different from the first overall visual effect, with the cap shingle being configured to be installed in an overlapping manner on a hip or ridge of a roof with either the first or the second prime colors being exposed.

25. The cap shingle of claim 24 in which the cap shingle is a metallic material.

26. The cap shingle of claim 24 in which the cap shingle is comprised of a substrate coated with an asphalt coating, with the first prime region being substantially covered by prime granules having the first overall visual effect and the second prime region being substantially covered by prime granules having the second overall visual effect.
